(19) United States
(12) Patent Application Publication
(10) Pub. No.: US 2004/0213391 A1
(43) Pub. Date: Oct. 28, 2004

(54) Calling card system

(76) Inventors: Ponti Horon Yau, Vancouver (CA); Gin Chung Lee, Burnaby (CA)

Correspondence Address: Mark Ming-Jen Yang, 800 - 885 West Georgia Street, Vancouver, BC, V6C 3H1, CA

(21) Appl. No.: 09/732,655

(22) Filed: Dec. 5, 2000

(51) Int. Cl. H04M 15/00; H04M 17/00

(52) U.S. Cl. 379/114.01; 379/144.01; 379/127.01

(57) ABSTRACT

The present invention is a method and system for allowing a local user of a calling card to allow remote users to make calls charged to such card. An association is created between a telephone number associated with the local user, the calling card, a remote telephone number, and an access number. A remote user can call the an access number and enter the access code and will thereby be connected to the telephone number associated with the local user.

### FIELD OF INVENTION

This invention relates to prepaid calling card systems, and more particularly to such systems allowing users in locations remote from the calling card to make calls charged to prepaid accounts associated with such card.

### BACKGROUND OF INVENTION

Individuals away from home, for example students, often use prepaid calling cards to make long distance calls to their family or friends. Such cards are useful for one way communications, for example from the student to his or her family, but are less useful when calls are being made to the student from a remote location. For example, for someone to use the calling card to make phone calls from a remote location, the PIN associated with the card would have to be memorized or recorded. Furthermore calls from the remote location may not be able to call the telephone number provided to use the card without incurring long distance charges. In some circumstances, the users at the remote location may be able to purchase their own cards, but the availability of calling cards may be limited at the remote location and may be subject to greater fees.

There have been disclosed a number of systems for allowing users in remote locations to charge calls to calling cards or accounts purchased or controlled elsewhere. An example of this is disclosed in U.S. Pat. No. 5,859,900 to Bauer et al., entitled “universal Call Access with Reverse Billing”, which discloses a system wherein callers can dial a toll free number, the phone number to be reached, and optionally a verification number. If the phone number dialled has preauthorized these sort of calls to be made, the call will be completed and charged to the account related to the number dialled. This system allows for calls to be made from any location to the accepting phone number, and is thus susceptible to abuse beyond its intended purpose.

U.S. Pat. No. 5,666,405 to Weber discloses a true family telecommunication system. In this system a single phone number can be dialled from a number of different locations. Once the membership of the phone number or individual (via a PIN) is established, all charges for a call from one member to another are billed to the same source. This system is difficult to set up, as it requires a unique phone number for a member to call to access the database linking the membership information with the account (for instance a 1-800 number), and lacks flexibility (i.e. it is difficult to remove or add members). Furthermore, it remains open for abuse (members may call each other at will, potentially resulting in large bills for the payor behind the account) and is expensive to implement (as it includes the cost of maintaining the extra phone number).

U.S. Pat. No. 5,675,607 to Alesio et al. describes a method and apparatus for facilitating the making of calling card calls. This system includes a database for associating a calling card PIN with a telephone station from which calls are made to simplify the calling process, but fails to provide an association between a card, a calling station and the number called.

U.S. Pat. No. 5,825,863 to Walker discloses a prepaid limited usage calling card. This system only allows calls to certain authorized numbers, as stored in a database associated with the card. While this system makes it more difficult to abuse a card, it also reduces the flexibility afforded by a calling card.

There are callback cards currently available on the market, which provide a means for users of such cards to take advantage of varying international phone rates. A user using such a card performs the following steps: (1) they call a phone number to access the system, (2) they enter a PIN and the phone number from which they are calling (if necessary); (3) they hang up the phone; (4) the system calls the authorized or detected phone number; whereupon (5) the user can answer the phone and (6) dial the number to be reached.

What is needed is a system wherein a calling card can be associated with both a phone number called from (the “local telephone number”) and a remote phone number called (the “remote telephone number”), such that someone using a telephone associated with the remote telephone number can call the local telephone number using the account associated with the aforementioned calling card.

### SUMMARY OF THE INVENTION

A system for providing telecommunications services using a prepaid calling card associated with an account is provided, said calling card having a PIN, a local access telephone number and a remote access telephone number. The system further comprises a local telephone associated with a local telephone number, a remote telephone associated with a remote telephone number, and a database associating said calling card with said remote telephone number, said local telephone number and an access code, such that by calling said remote access telephone number from said remote telephone number, and entering said access code, and a destination telephone number, such call will be charged to said account.

A method for providing telecommunications services using a prepaid calling card associated with an account, a PIN, a local access telephone number and a remote access telephone number, comprising the steps of: (a) providing a local telephone associated with a local telephone number; (b) providing a remote telephone associated with a remote telephone number; (c) calling said local access telephone number from said local telephone; (d) entering said PIN; (e) associating said calling card with said remote telephone number and said local telephone number; and (f) assigning an access code to said association, such that by calling said remote access telephone number from said remote telephone number, entering said access code, and calling a telephone number, such call will be charged to said account.

### BRIEF DESCRIPTION OF DRAWINGS

Advantages of the present invention will become apparent from the following detailed description taken in conjunction with preferred embodiments shown in the accompanying drawings, in which:

FIG. 1 is a block diagram of a system according to the invention;

FIG. 2 illustrates a flow chart showing the steps taken by a user of a prepaid calling card to associate a remote telephone number with such card in a system according to the invention;

FIG. 3 illustrates a flow chart showing the steps by a remote user to use such calling card in a system according to the invention; and

FIG. 4 is a block diagram of a computer used in a system according to the invention.

### DETAILED DESCRIPTION OF THE PREFERRED EMBODIMENTS

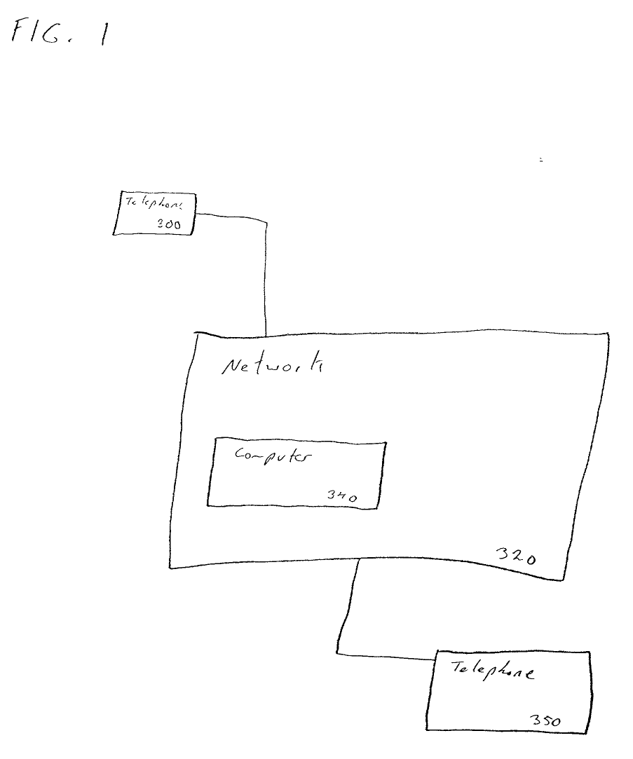

The method and apparatus of the present invention will now be discussed with reference to FIGS. 1 through 4. As best seen in FIG. 1, a system according to the invention requires a local telephone 300 associated with a local telephone number, connected to a network 320, a computer 340 with a database in connection with said network, and a remote telephone 350 associated with a remote phone number also connected to network 320.

The present invention is described in the context of prepaid calling cards for long distance phone usage. However, the system can be implemented for use with other resources, such as internet usage, cellular phone usage and other uses in which time limits and connectivity play a role. In addition, while the invention is discussed using a calling card having a Personal Identification Number (“PIN”) and an access telephone number (i.e. a telephone number to be called by the user of the calling card to access the system and enter the PIN), the PIN and access telephone number can be distributed to the user in a variety of ways, such as on a paper receipt, by verbal communications or by accessing an Internet web page. Furthermore, while the invention will be disclosed with respect to a callback system, the system could be implemented with the need of callbacks to the remote user.

In this document, the terms “local” and “remote” are used in relation to the prepaid calling card. A “local” telephone number or user is in relation to the holder of the card, for example the phone number maintained by the purchaser of the card. A “remote” telephone or “remote” user is remote in relation to the local user or telephone, and may be as close as a different area code or as far away as a different country or continent.

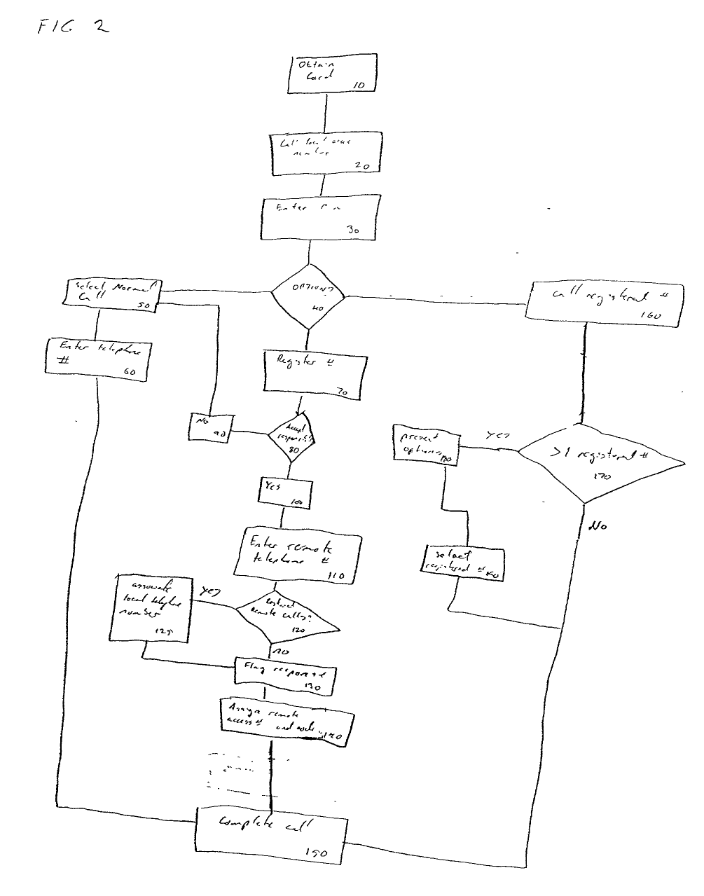

Following the flow chart seen in FIG. 2, a local user of a prepaid phone card for use with a system according to the invention will typically obtain such a card from a vendor (step 10). Such prepaid cards are available from a variety of sources, such as vending machines or at retail locations, and may even be given away by companies to employees or as promotional tools. Prepaid cards are associated with an account having a predetermined value, for example $20 or $50, and usually printed with both a local access telephone number and a PIN. The value of the account associated with a card is stored in computer 340.

In normal use of a prepaid calling card known in the art, a local user will call the local access telephone number, enter the PIN when prompted, and then dial a remote telephone number to reach a remote user. The computer 200 will keep track of the time of the connection of the call and the account associated with calling card via the PIN and deduct the appropriate amount from the account during each call. The local access number associated with the card is preferably a telephone number that can be called without incurring long distance charges in the area in which the cards are sold. Frequently the local access telephone number will be a 1-800 number and there may be more than one local access telephone number associated with a card, for example to allow users who speak different languages to access the services (by calling different access telephone numbers, such users will hear prerecorded messages taped in different languages).

According to a system as provided by the invention, after a call to the local access telephone number is made by the local user (step 20), and the PIN associated with the calling card is entered (step 30), the local user is preferably prompted with three options (step 40): (1) to use the card as a normal prepaid calling card; (2) to register the telephone number to be called; or (3) to call a previously registered remote telephone number.

If the local user selects option (1) (step 50), they are prompted to enter a telephone number (step 60) and the call is processed normally as with calling cards known in the art, to connect the local user with a remote telephone (step 150).

If the local user selects option (2) (step 70), the local user is prompted with a yes/no question as to whether the local user wants to allow the remote user of a telephone associated with a remote telephone number to use the account associated with the calling card, and if so, if the local user is willing to accept responsibility for such remote user's use (step 80). If the local user refuses (step 90), the local user may then make a call ordinarily, and is shifted to the normal use routine. If the local user accepts (step 100), the local user is prompted to enter the remote telephone number to be registered (step 110). The local user is preferably further prompted as to whether they wish to allow the remote user (or others using telephones associated with the remote telephone number) to make telephone calls to other telephone numbers other than the local telephone number (step 120). If the local user does want tot restrict calls made by a user of the remote telephone, then a telephone number selected by the local user is associated with the record related to the calling card (step 125). This may be done by prompting the local user to enter a telephone number or to associate the telephone number called from with the calling card automatically. The yes/no (step 130) response to this question is flagged in the database 500 in the record 510 associated with the calling card.

The computer then assigns a remote access telephone number and an access code to the registration (step 140) and completes the call to the remote phone number (step 150). The remote access telephone number is typically assigned based on the remote telephone number, for example by using the area code of such number. The access code may be identical to the PIN number associated with the calling card, but preferably is a shorter number, and even more preferably may be selected by the local user. The remote user, on answering the telephone associated with the remote telephone number may be given the remote access number, the PIN, and the access code (either verbally from the local user, or via an automated message) to utilize the services available on the system pursuant to the invention. The remote access telephone number may be a telephone number appropriate for the location of the remote user, or it may be the same number as the local access telephone number, or an 1-800 number.

If the local user selects (3), (for example by typing a character, such as “*” after entering the PIN) (step 160), the computer will determine the number of registrations associated with the calling card (step 170). If there is only one remote telephone number associated with the calling card, the computer completes the call to the registered remote telephone number (step 150). If there are several such telephone numbers registered, the computer will prompt the local user to select from a list of the registered phone numbers (step 180). After the local user has selected the registration (step 190), the computer will complete the call to the number selected (step 150).

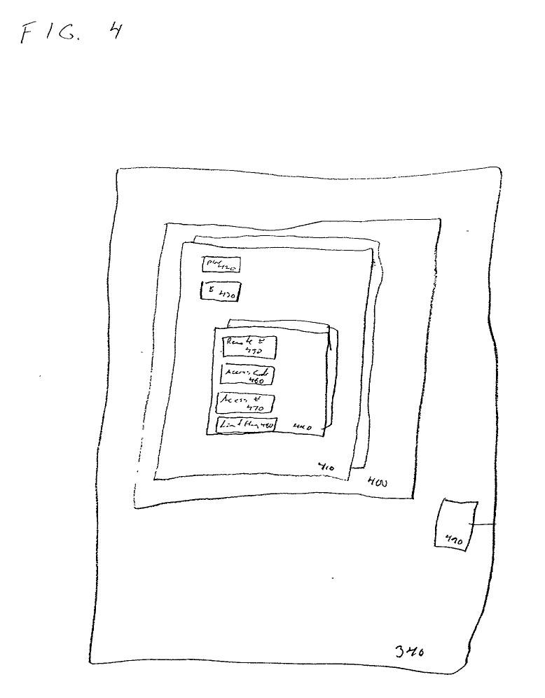

The local user may register more than one remote telephone numbers in association with a calling card. Preferably, each remote telephone number will be associated with its own access code. Remote access numbers are local or toll-free telephone numbers provided to allow remote users dialling from a registered remote phone number to access the database 400 in computer 340 and use the calling card. Computer 340 will include communications means 490, as known in the art to receive input from the local and remote users and send output to the local and remote users. As best seen in FIG. 4, the database 400 contains records for each calling card 410 and each such record includes fields for the PIN 420, the value remaining on the card 430 and subrecords 440 for each registered remote number. Such subrecords 440 will preferably include fields for the remote phone number 450, the access code 460, the access number 470, and the destination choice flag 480. Some of these fields may not be necessary, for example if the remote access number and the local access number are the same or if the access code and the PIN are the same.

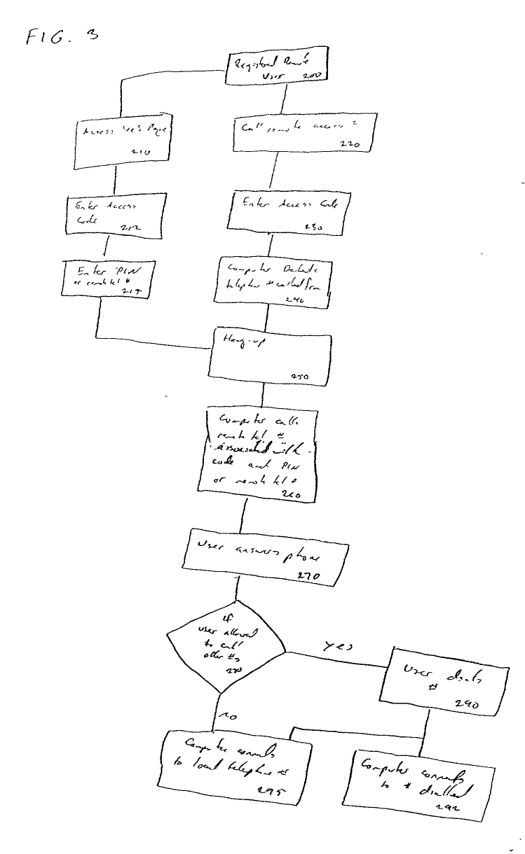

As best seen in FIG. 3, a remote user using a telephone associated with a registered remote telephone number (step 200) can make calls and have the cost of such calls deducted from the local user's calling card. Such a remote user does so by entering the appropriate information when requested by the system according to the invention. In one embodiment of the system, the remote user could access the calling card account by visiting a web page (step 210) and entering the access code (step 212) and either the remote telephone number or PIN (step 215).

If the remote user is using a telephone, the remote user will call the remote access telephone number (step 220). Preferably, the remote user will call from a telephone associated with the registered remote telephone number, although this is not necessary to operate the system. The remote user is then prompted to enter the access code (step 230).

The computer will detect the number being called from (or entered on the web page) and will look up the record in the database relating to such telephone number and access code (step 240). Alternatively, the computer may request the PIN associated with the calling card and use the access code and PIN to obtain the appropriate record. The remote user then waits and/or hangs up the telephone to clear the line to the remote telephone number (step 250). The computer system then autodials the registered remote telephone number (step 240) associated with the appropriate record.

In an alternative embodiment of the invention, the remote user, rather than waiting for the computer to call the remote telephone number, may simply be connected to the local telephone number associated with the registration (or may select a phone number to dial if such option is available). This has the advantage of requiring less steps, but may be a more expensive means of connecting the calls depending on the nature of the remote user's telephone system.

The remote user then answers the telephone associated with the remote telephone number and obtains a dial tone (step 270). The computer then checks the multiple destination flag in the appropriate record (step 280). If the remote user is authorized to enter destination choices (i.e. the destination choice flag is “yes” in the record), the remote user has the option of dialing any phone number or may press an appropriate key (for example the * key) to autodial the local telephone number (step 290). The remote user is then connected to the appropriate telephone (step 292). If the remote user is not so authorized, the computer autodials the local phone number (step 295). All charges associated with the call we be deducted from the calling card.

In yet another embodiment of the invention, voice recognition systems known in the art can be used to identify the local and remote users. For example instead of associating the calling card and its PIN with local and remote telephone numbers, the association could be made with the local user voice pattern and/or the remote user voice pattern. No access code would be needed, as computer 340 would include voice pattern recognition software, and would recognize the voice of the local and/or remote user. It would also be possible to eliminate the need for using the PIN more than once (to set up the local user voice pattern). The advantage to this is embodiment is that it frees the local and remote users from reliance on calling from a particular telephone and reduces the amount of information that must be stored by the local and remote users to use the invention. In the case where the remote user may only use the card to contact the local user, it is also preferable to associate the local telephone number with the card, as in the previously described embodiments.

In yet another embodiment of the invention, the remote user could prepare the associations necessary to use the system. For example, the remote user may be prompted at the end of a call, or by instructions of the local caller to enter the information necessary for the association.

Those skilled in the art will recognize that the method and apparatus of the present invention has many applications, and that the present invention is not limited to the representative examples disclosed herein. For example, while the invention has been discussed with respect to prepaid long distance telephone cards, other services may be used with the cards such as cellular phone time or internet access time. Moreover, the scope of the present invention covers conventionally known variations and modifications to the system components described herein, as would be known by those skilled in the art.

1. A method for providing telecommunications services using a calling card associated with an account, a PIN, a first access telephone number and a second access telephone number, comprising the steps of:
a) providing a first telephone associated with a first telephone number;
b) providing a second telephone associated with a second telephone number;
c) calling said first access telephone number from said first telephone;
d) entering said PIN;
e) associating said calling card with said first telephone number and said second telephone number; and
f) assigning an access code to said association, such that by calling said second access telephone number from said second telephone, entering said access code, and calling a telephone number, such call will be charged to said account.

2. The method of claim 1, wherein said call from said second telephone may be made only to said first telephone number.

3. The method of claim 1, wherein said first access telephone number and said second access telephone number are the same telephone number.

4. The method of claim 1, wherein a multiplicity of telephone numbers are associated with said first telephone number.

5. A method of allowing a user using a first telephone associated with a first telephone number to make calls charged to an account associated with a prepaid calling card of a second user, comprising the steps of:
a) said second user, in a database, associating said calling card with said first telephone number and an access code;
b) said first user calling a remote access telephone number from said first telephone;
c) said first user entering said access code;
d) said first user calling a second telephone number.

6. The method of claim 5, wherein said second telephone number is only to a telephone number associated with said calling card by said second user.

7. The method of claim 5, wherein a multiplicity of telephone numbers are associated with said calling card.

8. A system for providing telecommunications services using a calling card associated with an account, said calling card having a PIN, a first access telephone number and a second access telephone number, comprising:
a) a first telephone associated with a first telephone number;
b) a second telephone associated with a second telephone number;
c) a database associating said calling card with said second telephone number, said first telephone number and an access code, such that by
(i) calling said second access telephone number from said second telephone number, and
(ii) entering said access code, and
(iii) entering a destination telephone number,
such call will be charged to said account.

9. The system of claim 8, wherein calls from said second telephone will only be charged to said account when said destination number is said first telephone number.

10. The system of claim 8, wherein said first access telephone number and said second access telephone number are the same telephone number.

11. The method of claim 8, wherein a multiplicity of telephone numbers are associated with said calling card.

12. A method of allowing a first user having a voice recognition pattern, using a first telephone associated with a first telephone number to make calls charged to an account associated with a prepaid calling card of a second user, comprising the steps of:
a) said second user associating said calling card with said first telephone number and said voice recognition pattern, in a database;
b) said first user calling a remote access telephone number from said first telephone;
c) recognizing said voice recognition patter;
d) said first caller calling a second telephone number.

13. The method of claim 12, wherein said call from said first telephone number may only be to said second telephone number.

14. The method of claim 13, wherein a multiplicity of telephone numbers are associated with said calling card.

15. A system for providing telecommunications services using a calling card associated with an account, said calling card having a PIN, a first access telephone number and a second access telephone number, comprising:
a) a first telephone associated with a first telephone number;
b) a second telephone associated with a second telephone number;
c) a database associating said calling card with said second telephone number, said first telephone number and a voice recognition pattern, such that by calling said second access telephone number from said second telephone number, and recognizing said voice recognition pattern, and entering a destination telephone number, such call will be charged to said account.

16. The method of claim 15, wherein said destination number must be said first telephone number.

17. The method of claim 15, wherein said first access telephone number and said second access telephone number are the same telephone number.

18. The method of claim 15, wherein a multiplicity of telephone numbers are associated with said first telephone number.

19. A system for providing telecommunications services using a calling card associated with an account, said calling card having a PIN, a first access telephone number and a second access telephone number, comprising:
a) a first telephone associated with a first telephone number;
b) a second telephone associated with a second telephone number; and
c) a database associating said calling card with said second telephone number, said first telephone number and a voice recognition pattern, such that by communicating said access number to said database, and entering a destination telephone number, such call will be charged to said account.

20. The method of claim 8, further comprising step (c)(ii.1) receiving a callback call.

21. A system for paying for telecommunications services using an account, said account associated with a PIN, and an access telephone number, comprising:
a) a first telephone associated with a first telephone number;
b) a second telephone associated with a second telephone number; and
c) a database associating said account with said second telephone number, said access code and said first telephone number such that by communicating said access number to said database, and entering a destination telephone number, such call will be charged to said account.

22. A method for providing telecommunications services using a calling card associated with an account, a PIN, a first access telephone number and a second access telephone number, comprising the steps of:
a) providing a first telephone associated with a first telephone number;
b) providing a second telephone associated with a second telephone number;
c) calling said first access telephone number from said first telephone;
d) entering said PIN;
e) associating said calling card with said first telephone number and said second telephone number;
f) assigning an access code to said association, such that by calling said second access telephone number from said second telephone, and entering said access code;
g) calling said second telephone number;
h) entering a destination telephone number; and
i) charging such call to said account.
